(19) United States
(12) Patent Application Publication
(10) Pub. No.: US 2017/0238328 A1
(43) Pub. Date: Aug. 17, 2017

(54) ACQUISITION THRESHOLD BASED ON SIGNAL STRENGTH

(71) Applicant: QUALCOMM Incorporated, San Diego, CA (US)

(72) Inventors: Le Nguyen LUONG, San Diego, CA (US); RaviKiran GOPALAN, Solana Beach, CA (US)

(21) Appl. No.: 15/045,137

(22) Filed: Feb. 16, 2016

(51) Int. Cl. H04W 72/08; H04L 12/26; H04W 4/00

(52) U.S. Cl. CPC H04W 72/085; H04W 4/008; H04L 43/16

(57) ABSTRACT

Systems and methods pertain to operating a receiver of wireless signals such as Bluetooth or Bluetooth Low Energy (BLE) signals. A correlator is provided to correlate a wireless signal received by the receiver with a device identifier corresponding to a wanted device from which the receiver wants to receive wireless signals, to generate a correlator output. An adaptive acquisition threshold generator generates an adaptive acquisition threshold based on a signal strength of the wireless signal, and a comparator is used to determine if the wireless signal is a wanted signal intended for the receiver, based on a comparison of the correlator output with the adaptive acquisition threshold.

### FIELD OF DISCLOSURE

Disclosed aspects are related to wireless communications. More specifically, exemplary aspects are related to adapting acquisition thresholds in receivers for wireless signals such as Bluetooth, Bluetooth Low Energy (BLE), etc., based on received signal strength of the wireless signals.

### BACKGROUND

A wireless communication device which may be compatible with wireless signals such as Bluetooth, BLE, etc., may include mechanisms to receive compatible wireless signals, detect whether a received wireless signal is a “wanted signal” or a signal intended for the wireless communication device, and if the received signal is a wanted signal, then decode the wanted signal for further processing. Specifically, in the case of a receiver configured to receive Bluetooth or BLE signals, the receiver may store a device identifier corresponding to a “wanted device” or a device that the receiver wants to receive wireless signals from. Data packets in the received Bluetooth or BLE signals (e.g., a Bluetooth packet or a BLE packet, respectively) also include a device identifier of the device that transmitted the data packets (wherein, the device identifiers are referred to as a “SyncWord” or “AccessAddress” in the protocols used for Bluetooth packets and BLE packets, respectively).

Correlation between a received signal and the device identifier of a wanted device is computed, for example, using a correlator in the receiver. The computed correlation is compared with an acquisition threshold to determine whether the correlation is high or low. If the computed correlation is high, then the received signal is determined as being a wanted signal or from a wanted device, and the received signal may be processed further by the receiver; and if the computed correlation is low, then the received signal is determined to be an “unwanted signal” or not from a wanted device, and further processing of the received signal may be avoided.

However, false determinations of wanted or unwanted signals are possible based, among other factors, on the acquisition threshold. For example, if a received signal is in fact a wanted signal but the received signal is noisy (or has a low signal-to-noise ratio (SNR), as known in the art), the computed correlation may be low due to the noise. Thus, when compared with the acquisition threshold, the received signal may be deemed as an unwanted signal. In order to avoid this, conventional receivers design their acquisition threshold to be optimized for received signals with low SNRs. But an acquisition threshold optimized for low SNR signals may not be well-suited for received signals with high SNRs. This is because it is possible for some received signals with high SNRs to be falsely determined as wanted or unwanted based on a comparison of their corresponding computed correlation with an acquisition threshold designed for received signals with low SNRs. Although the rate of such false determination (or error rate) may be low, it nevertheless sets an undesirable error floor. Due to the packet format of BLE signals, the error floor may be higher for detection of BLE signals in comparison with detection of Bluetooth signals.

Accordingly, it is desirable to lower or eliminate the error floor, and more generally to optimize performance of the Bluetooth and BLE receivers across the various ranges of SNRs of received Bluetooth or BLE signals.

### SUMMARY

Exemplary aspects are directed to systems and methods for operating a receiver of wireless signals such as Bluetooth or Bluetooth Low Energy (BLE) signals. A correlator is provided to correlate a wireless signal received by the receiver, with a device identifier (e.g., of a wanted device) to generate a correlator output. An adaptive acquisition threshold generator generates an adaptive acquisition threshold based on a signal strength of the wireless signal, and a comparator is used to determine if the wireless signal is a wanted signal intended for the receiver, based on a comparison of the correlator output with the adaptive acquisition threshold.

For example, an exemplary aspect is directed to apparatus comprising a correlator configured to correlate a wireless signal received by the apparatus, with a device identifier to generate a correlator output. The apparatus further comprises an adaptive acquisition threshold generator configured to generate an adaptive acquisition threshold based on a signal strength of the wireless signal, and a comparator configured to determine if the wireless signal is a wanted signal intended for the apparatus, based on a comparison of the correlator output with the adaptive acquisition threshold.

Another exemplary aspect is directed to a method of operating a receiver of wireless signals, the method comprising receiving a wireless signal, correlating the wireless signal with a device identifier, to generate a correlator output, generating an adaptive acquisition threshold based on a signal strength of the wireless signal, and comparing the correlator output with the adaptive acquisition threshold to determine if the wireless signal is a wanted signal intended for the receiver.

Another exemplary aspect is directed to a system comprising means for receiving a wireless signal, means for correlating the wireless signal with a device identifier, means for generating an adaptive acquisition threshold based on a signal strength of the wireless signal, and means for comparing an output of the means for correlating with the adaptive acquisition threshold, for determining if the wireless signal is a wanted signal for the means for system.

Yet another exemplary aspect is directed to a non-transitory computer-readable storage medium comprising code, which, when executed by a processor, causes the processor to perform functions for operating a receiver, the non-transitory computer-readable storage medium comprising code for receiving a wireless signal, code for correlating the wireless signal with a device identifier, to generate a correlator output, code for generating an adaptive acquisition threshold based on a signal strength of the wireless signal, and code for comparing the correlator output with the adaptive acquisition threshold to determine if the wireless signal is a wanted signal for the receiver.

### BRIEF DESCRIPTION OF THE DRAWINGS

The accompanying drawings are presented to aid in the description of aspects of the disclosure and are provided solely for illustration and not limitations thereof.

FIG. 1 illustrates a wireless communication system, according to an aspect of this disclosure.

FIGS. 2A-B illustrate example formats for a Bluetooth AccessCode and a Bluetooth Low Energy (BLE) packet, according to an aspect of this disclosure.

FIG. 3 illustrates a schematic view of an acquisition block of in a wireless device that is capable of communications using Bluetooth and BLE protocols.

FIG. 4 illustrates a schematic view of an initial acquisition threshold generator, according to an aspect of this disclosure.

FIG. 5 illustrates a schematic view of an adaptive acquisition threshold generator, according to an aspect of this disclosure.

FIG. 6 illustrates a flowchart pertaining to an acquisition process for Bluetooth and BLE signals.

FIG. 7 illustrates a method of operating a receiver, according to an aspect of this disclosure.

FIG. 8 illustrates an exemplary wireless device in which an aspect of the disclosure may be advantageously employed.

### DETAILED DESCRIPTION

Specific examples of the disclosure are described in the following description and related drawings. Alternate examples may be devised without departing from the scope of the disclosure. Additionally, well-known elements will not be described in detail or will be omitted so as not to obscure the relevant details of the disclosure.

The word “exemplary” is used herein to mean “serving as an example, instance, or illustration.” Any aspect described herein as “exemplary” is not necessarily to be construed as preferred or advantageous over other aspects. Likewise, the term “aspects” does not require that all aspects include the discussed feature, advantage, or mode of operation.

The terminology used herein is for the purpose of describing particular aspects only and is not intended to be limiting of the aspects. As used herein, the singular forms “a,” “an,” and “the” are intended to include the plural forms as well, unless the context clearly indicates otherwise. It will be further understood that the terms “comprises,” “comprising,” “includes,” or “including,” when used herein, specify the presence of stated features, integers, steps, operations, elements, or components, but do not preclude the presence or addition of one or more other features, integers, steps, operations, elements, components, or groups thereof. Moreover, it is understood that the word “or” has the same meaning as the Boolean operator “OR,” that is, it encompasses the possibilities of “either” and “both” and is not limited to “exclusive or” (“XOR”), unless expressly stated otherwise. It is also understood that the symbol “/” between two adjacent words has the same meaning as “or” unless expressly stated otherwise. Moreover, phrases such as “connected to,” “coupled to,” or “in communication with” are not limited to direct connections unless expressly stated otherwise.

Further, many aspects are described in terms of sequences of actions to be performed by, for example, elements of a computing device. It will be recognized that various actions described herein can be performed by specific circuits, for example, central processing units (CPUs), graphic processing units (GPUs), digital signal processors (DSPs), application-specific integrated circuits (ASICs), field programmable gate arrays (FPGAs), or various other types of general purpose or special purpose processors or circuits, by program instructions being executed by one or more processors, or by a combination of both. Additionally, the sequence of actions described herein can be considered to be embodied entirely within any form of computer-readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

Exemplary aspects of this disclosure pertain to a receiver of wireless signals, the receiver comprising an acquisition block configured to provide an adaptive acquisition threshold based on a signal strength of a wireless signal received by the receiver. More specifically, the wireless signal may be a Bluetooth or BLE signal, wherein the acquisition threshold can be varied based on a received signal strength indications (RSSI) of the received signal. In this manner, the acquisition threshold can be increased or decreased, to improve detection and determination of whether a received signal is a wanted signal or an unwanted signal, wherein the signal strength or SNR of the received signal can vary from low to high. An error floor, as previously discussed in conventional receivers, can be eliminated or lowered, by adapting the acquisition threshold to the SNRs, or in exemplary implementations, the RSSI of the received signal.

As used in this disclosure, the term “wanted signal” refers to a wireless signal such as Bluetooth or BLE received by the receiver from a “wanted device.” As previously explained, the wanted device is a wireless communication device that the receiver intends to or wants to receive wireless signals from. A wanted device may have an associated device identifier (e.g., SyncWord in the case of Bluetooth signals or AccessAddress in the case of BLE signals) which may be stored in the receiver. The receiver may have a correlator to correlate a wireless signal received by the receiver with the device identifier stored in the receiver in the process of determining whether or not the wireless signal is a wanted signal. These and other exemplary aspects will be explained in further detail with reference to the figures, in the following sections.

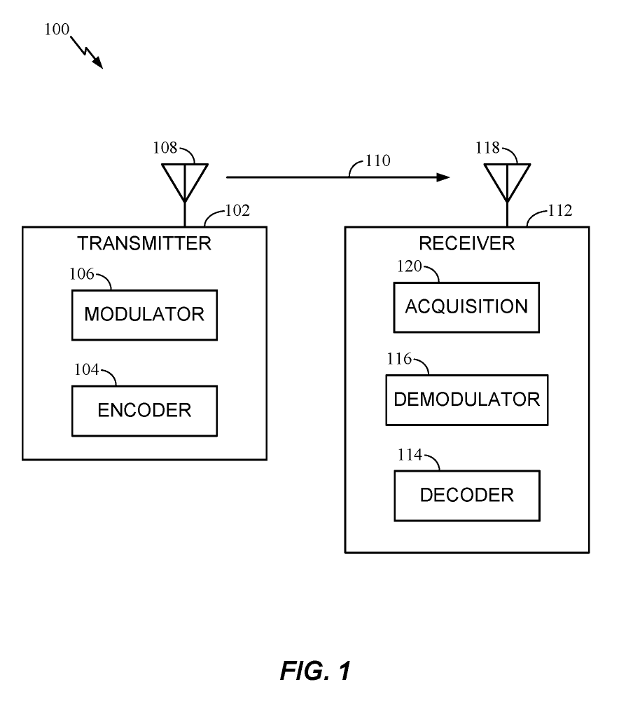

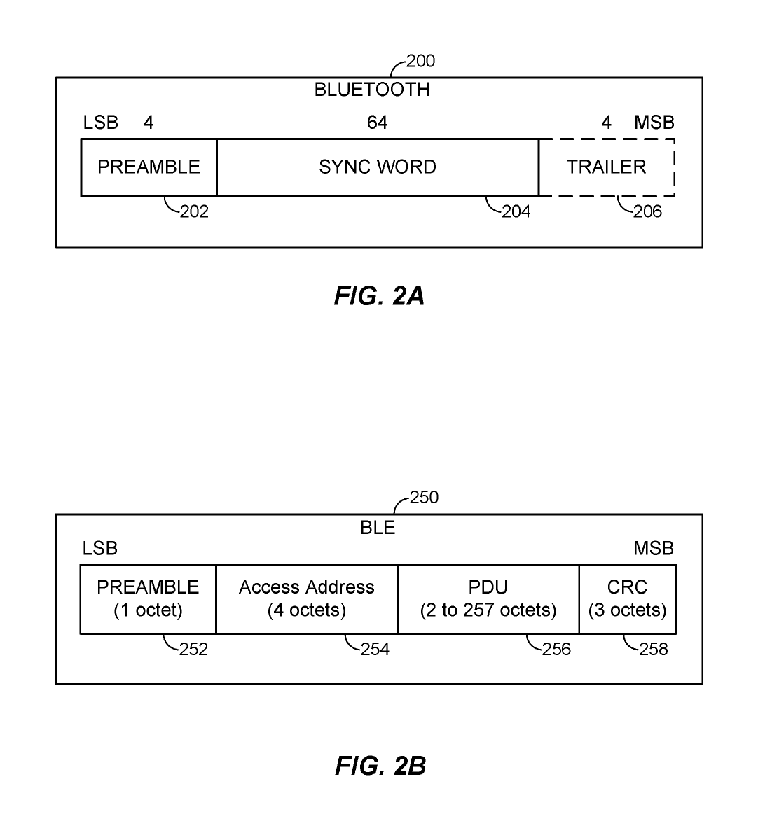

With reference now to FIG. 1, a simplified schematic diagram of an exemplary wireless communication system 100 is illustrated. Wireless communication system 100 may support communication of Bluetooth or BLE signals between transmitter 102 and receiver 112, in exemplary aspects. Exhaustive details of transmitter 102 and receiver 112 have been omitted for the purposes of this discussion, as skilled persons will recognize detailed configurations of these devices. As shown, transmitter 102 includes encoder 104 configured to encode information to be transmitted into a protocol-specific packet format (an example packet format for a Bluetooth AccessCode and a BLE packet are shown and explained with reference to FIGS. 2A-B below). Modulator 106 is configured to modulate the transmitted bits to Gaussian Frequency Shift Keying (GFSK) symbols, which are used to modulate a carrier at the carrier frequency of channel 110, and antenna 108 is configured to transmit wireless signals comprising the modulated carrier on channel 110. On the receiving end, receiver 112 may comprise antenna 118 configured to receive the wireless signals on channel 110. Acquisition block 120, which will be described in further detail in the following sections, may include functionality for detecting whether the wireless signals received are intended for receiver 112 (e.g., are wanted signals or are wireless signals from wanted devices), based on acquisition thresholds adapted to signal strength of the wireless signals received on channel 110. Symbols of the wanted signals are demodulated in demodulator 116, and decoded in decoder 114 in order to retrieve the information transmitted by transmitter 102.

With reference now to FIGS. 2A-B, example formats for a Bluetooth AccessCode and a BLE packet, respectively, are illustrated. With reference to FIG. 2A, Bluetooth AccessCode 200 is illustrated. Bluetooth AccessCode 200 may include several fields, some of which are shown in FIG. 2A. As shown, Bluetooth AccessCode 200 may include preamble 202, SyncWord 204, and optionally, trailer 206. Preamble 202 may occupy, for example, the four least significant bits (LSBs) of Bluetooth AccessCode 200, and may include patterns such as alternating zeros and ones (e.g., “1010” or “0101”). Preamble 202 may be followed by a device identifier such as Bluetooth Synchronization Word (SyncWord) 204. SyncWord 204 may be, for example, 64-bits wide and will be explained further in the following sections. The optional trailer 206 may occupy the four most significant bits (MSBs) of Bluetooth AccessCode 200. Where used, trailer 206 may include patterns such as alternating zeros and ones (e.g., “1010” or “0101”), which may be further helpful in symbol timing and initial carrier frequency offset estimations, based, for example, the zero crossings or other waveform information associated with such patterns.

In further detail, SyncWord 204 may be a device identifier used by receiver 112 (e.g., within acquisition block 120) to detect whether a received signal is a wanted signal, or more specifically, whether a received Bluetooth packet comprises Bluetooth AccessCode 200 corresponding to a wanted device. SyncWord 204 may also be optionally used for synchronization of frequency and/or time, including, for example, carrier frequency offset and/or symbol timing (e.g., functions which may be performed in demodulator 116 of FIG. 1, but not explained in exhaustive detail in this disclosure). SyncWord 204, for example of 64-bits, may be derived from a 24-bit address using a (64, 30) expurgated block code with an overlay (bit-wise XOR) of a 64-bit full-length pseudo-random noise (PN) sequence, as known in the art. This method of generating SyncWord 204 is meant to guarantee a minimum Hamming distance between two SyncWords (i.e., in a simplified form, the minimum difference in address bits between two SyncWords, for telling them apart) is 14.

With reference now to FIG. 2B, an example Bluetooth Low Energy (BLE) packet 250 is illustrated with example fields. Like Bluetooth AccessCode 200, BLE packet 250 also includes preamble 252. Preamble 252 may have a length of one octet (8-bits) in the illustrated example, and may be followed by a device identifier similar to SyncWord 204 of Bluetooth AccessCode 200. However, in the format of BLE packet 250, the device identifier is referred to as an Access Address, and illustrated as AccessAdress 254. AccessAddress 254 may have a length of four octets (32-bits), which may be followed by a Payload Data Unit (PDU) 256, for example, of length in the range of 2 to 257 octets. These fields may also be followed by an error-correction field such as Cyclical Redundancy Check (CRC) 208 having a length of three octets (24-bits).

In further detail, in the case of BLE packet 250, AccessAddress 254 may be a device identifier used by a receiving device (e.g., in acquisition block 120 of receiver 112) to determine whether a received BLE packet 250 is a packet of a wanted signal (i.e., AccessAddress 254 corresponds to the device identifier of a wanted device). In some instances, AccessAddress 254 may also be optionally used for synchronization of frequency and/or time, including, for example, carrier frequency offset and/or symbol timing (e.g., functions which may be performed in demodulator 116 of FIG. 1, but not explained in exhaustive detail in this disclosure). However, unlike SyncWord 204, AccessAddress 254 may be at least partially randomly generated (keeping in mind that in some implementations, there may be some constraints on the generation of AccessAddresses for different packets and the generation of AccessAddresses may not be entirely random). Whether or not the generation of AccessAddress 254 is entirely random or partially random, AccessAddress 254 may be any 32-bit combination of 0's and 1's, which means that the minimum Hamming distance between two AccessAddresses may be as small as one. As can be appreciated, with a smaller minimum Hamming distance in the case of BLE signals, correlating received signals to a device identifier may be a bigger challenge.

In order to improve the correct determination of received signals, e.g., Bluetooth and/or BLE, as wanted signals or unwanted signals, exemplary aspects include an adapting acquisition threshold based on signal strength of the received signals. To explain these aspects, a further detailed description of receiver 112, and more specifically, features of acquisition block 120 will now be provided.

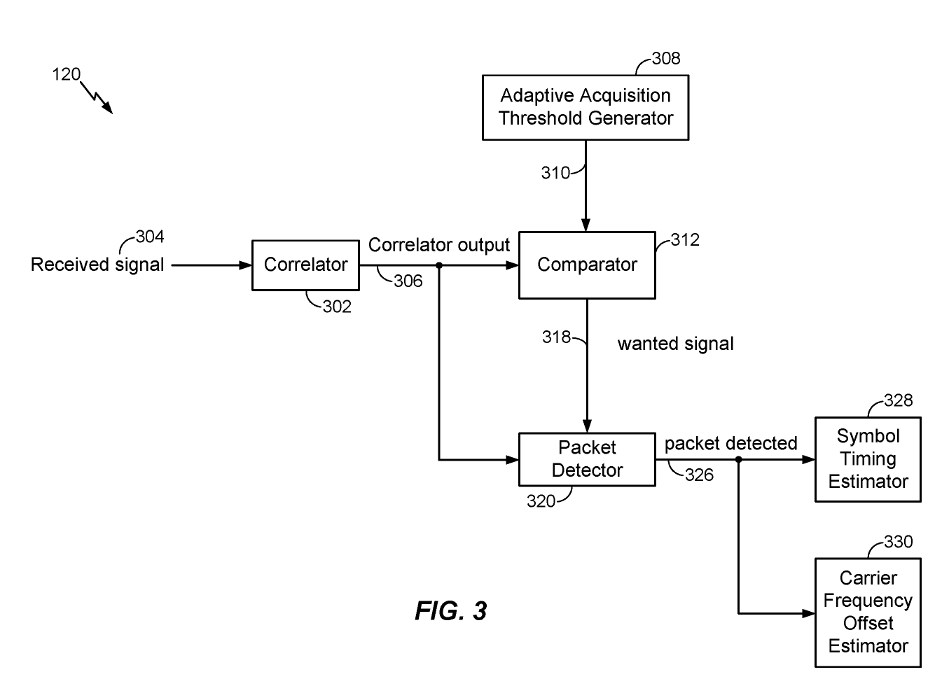

With reference to FIG. 3, selected aspects of acquisition block 120 are shown. As previously explained, receiver 112 may be configured to receive wireless signals such as Bluetooth, BLE signals, etc., via antenna 118. A wireless signal received via antenna 118 is representatively shown as received signal 304 in FIG. 3. Acquisition block 120 is further shown to include functional blocks identified as correlator 302, adaptive acquisition threshold generator 308, comparator 312, packet detector 320, symbol timing estimator 328, and carrier frequency offset estimator 330. These functional blocks and their interactions will now be explained in further detail, while keeping in mind that various other combinations, configurations, and arrangements of the functional blocks to achieve the functionality described herein, are possible within the scope of this disclosure.

Received signal 304 is provided to correlator 302 for correlating received signal 304 with a device identifier (e.g., of a wanted device). Although not specifically shown, correlator 302 may include or have access to a memory or storage device comprising the device identifier. Correlator 302 may be configured to correlate received signal 304 with the device identifier. The correlation may be performed using any correlation function (e.g., a matched filter) to determine the correlation between received signal 304 and the device identifier.

An output of correlator 302 is identified as correlator output 306, wherein correlator output 306 quantifies a match between the received signal and the device identifier (e.g., an expected SyncWord or AccessAddress of a wanted device). Using conventional correlation functions such as a matched filter, correlator output 306 may be at its maximum magnitude when, for example, a bit pattern (or waveform) of the received signal matches a bit pattern (or waveform) of the device identifier (while keeping in mind that in some implementations, at its maximum magnitude, correlator output 306 may also satisfy other considerations such as a bit or symbol transition times between received signal 304 and receiver 112 being synchronized, a modulation index matches the transmitter modulation index for received signal 304, inter symbol interference is accounted for by correlator 302, etc.). A bit pattern (or waveform) match occurs when a received packet (e.g., a Bluetooth or BLE packet) of received signal 304 is intended for receiver 112 (i.e., received signal 304 is a wanted signal), while bit transition times are synchronized at a convolution time step where a matched filter signal output may be at its highest. Therefore, in determining whether a received packet is a packet of a wanted signal, correlator output 306, at its maximum value, for example, may be compared with an acquisition threshold value. As previously explained, the optimum acquisition threshold value for a particular received signal 304 may vary based on the signal's noisiness. Therefore, in exemplary aspects, the acquisition threshold value may be adapted to the strength of a received signal.

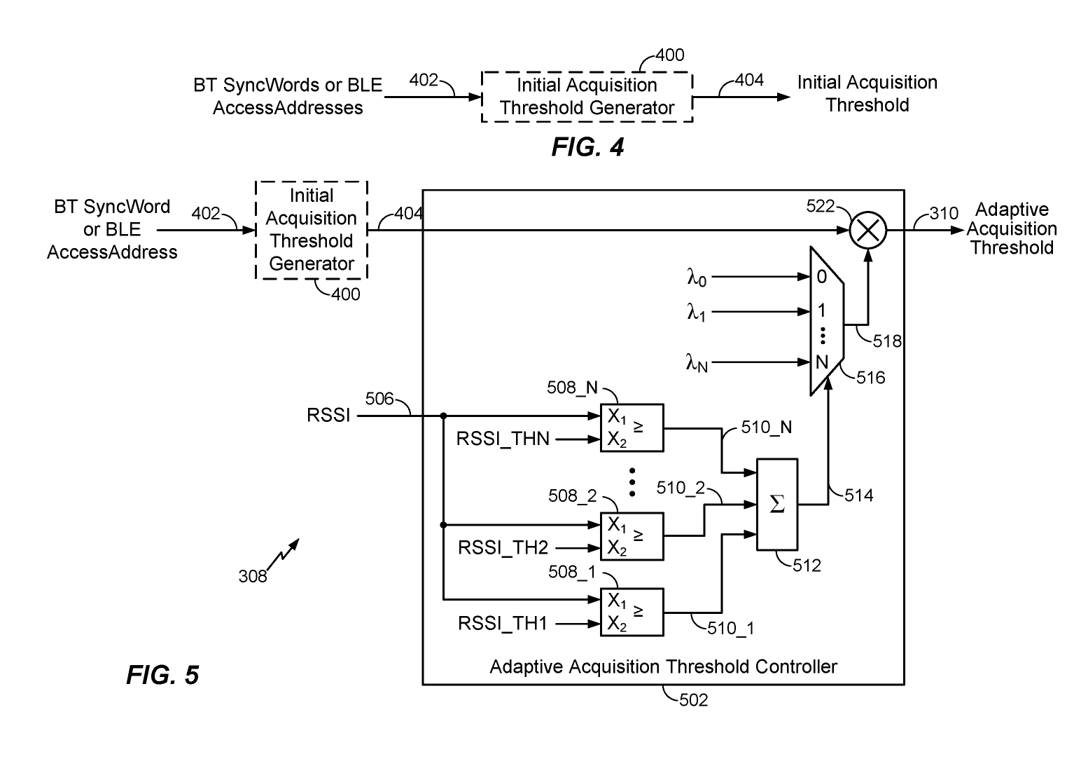

Adaptive acquisition threshold generator 308 is provided in the acquisition block 120 to generate adaptive acquisition threshold 310 based on signal strength of received signal 304, as explained further with reference to FIGS. 4-5 (wherein, for convenience of explanation, received signal 304 may be assumed to be normalized with regard to signal strength or magnitude in the correlator 302 before the correlation process). With continued reference to FIG. 3, adaptive acquisition threshold generator 308 is configured to generate adaptive acquisition threshold 310 as an output.

Comparator 312 is configured to receive adaptive acquisition threshold 310, as well as correlator output 306 and perform a comparison between adaptive acquisition threshold 310 and correlator output 306. If correlator output 306 is greater than adaptive acquisition threshold 310, comparator 312 asserts the signal depicted as wanted signal 318 at its output to indicate that the received signal 304 contains a packet of a wanted signal directed to or intended for receiver 112.

The blocks depicted as packet detector 320, symbol timing estimator 328, and carrier frequency offset estimator 330 will now be discussed briefly, while keeping in mind that exhaustive details of these blocks are beyond the scope of this disclosure. Based on the assertion of wanted signal 318, packet detector 320 can start a process of detecting a peak of the correlator output 306. Once the peak of the correlator output 306 has been detected, packet detector 320 asserts, at its output, the signal, packet detected 326. Based on packet detected 326, symbol timing estimator 328 may estimate the symbol timing of Bluetooth and/or BLE symbols and carrier frequency offset estimator 330 may estimate the carrier frequency offset of Bluetooth and/or BLE signals.

With reference to FIG. 4, an optional block pertaining to an initial acquisition threshold generator 400 is illustrated. Although in some aspects, initial acquisition threshold generator 400 may be omitted, the following description covers aspects where initial acquisition threshold generator 400 may be used. In general, to improve the probability of correctly detecting a wanted signal while reducing the probability of a false negative (or incorrect determination of an unwanted signal), it is recognized that the acquisition threshold may be initially set based on the particular device identifier (e.g., a SyncWord in the case of Bluetooth, or an AccessAddress in the case of BLE, corresponding to a wanted device). Accordingly, initial acquisition threshold generator 400 is provided with a device identifier for receiver 112, which may comprise a Bluetooth SyncWord and/or a BLE AccessAddress, representatively shown as input 402. Initial acquisition threshold generator 400 is configured to generate an initial acquisition threshold based on the received Bluetooth SyncWord or BLE AccessAddress on input 402 and provide initial acquisition threshold 404 at its output. In one aspect, initial acquisition threshold 404 may be a fixed acquisition threshold that may be optimized for received signals (e.g., received signal 304) displaying a low signal-to-noise ratio (SNR), but may or may not be optimal for received signals 304 with high SNR. As one of ordinary skill in the art would recognize, that there may be a high correlation between SNR and RSSI of received signal 304. Therefore, in the following sections, an RSSI of received signal 304 may be used as an indication of the SNR of received signal 304.

With reference to FIG. 5, an implementation of adaptive acquisition threshold generator 308 configured to adapt acquisition threshold to be optimized across a whole range of SNRs is illustrated. Referring to FIG. 5, adaptive acquisition threshold generator 308 includes the optional initial acquisition threshold generator 400, an example of which is described above with respect to FIG. 4. In FIG. 5, assuming initial acquisition threshold generator 400 is used, initial acquisition threshold 404 is generated based on a device identifier comprising a Bluetooth SyncWord or a BLE AccessAddress, as the case may be, of a wanted device. Adaptive acquisition threshold generator 308 also includes adaptive acquisition threshold controller 502. Initial acquisition threshold 404 is provided as one input to adaptive acquisition threshold controller 502. Another input to adaptive acquisition threshold controller 502 is shown as received signal strength indicator (RSSI) 506. RSSI 506 is based on a signal strength of received signal 304. RSSI 506 may be generated by a RSSI generator configured in receiver 112 (although an RSSI generator is not explicitly shown or exhaustively described, the RSSI generator may be implemented according to known techniques, such as computing a magnitude, or a square or logarithmic value of the received signal, for determining the strength of the received signal).

With continuing reference to FIG. 5, adaptive acquisition threshold controller 502 is configured to apply a scaling factor to initial acquisition threshold 404 based on RSSI 506, such that the acquisition threshold can be varied in an adaptive manner based on the signal strength of the received signals. In this regard, adaptive acquisition threshold controller 502 includes one or more threshold comparators for comparing the received signal strength with discrete signal strength threshold values, wherein N threshold comparators have been designated by the reference numerals 508_1, 508_2, . . . 508_N. Each one of RSSI threshold comparators 508_1, 508_2, . . . 508_N has two inputs, wherein one input is RSSI 506 and another input is a unique or discrete RSSI threshold varying in magnitude, shown in ascending order of magnitude as RSSI_TH1, RSSI_TH2, . . . RSSI_THN, i.e., RSSI_TH1<RSSI_TH2<<RSSI_THN.

RSSI 506 is compared with each of the RSSI thresholds RSSI_TH1, RSSI_TH2, . . . RSSI_THN in corresponding N RSSI threshold comparators 508_1, 508_2, . . . 508_N. If RSSI 506 is greater than one or more of RSSI thresholds RSSI_TH1, RSSI_TH2, . . . RSSI_THN, then the corresponding one or more RSSI threshold comparators 508_1, 508_2, . . . 508_N will output “1” on their corresponding RSSI threshold comparison outputs 510_1, 510_2, . . . 510_N. Otherwise, RSSI threshold comparators 508_1, 508_2, . . . 508_N which determine that RSSI 506 is less than their corresponding RSSI thresholds RSSI_TH1, RSSI_TH2, . . . RSSI_THN, will output “0” on their corresponding RSSI threshold comparison outputs 510_1, 510_2, . . . 510_N.

Thus, for example, if RSSI 506 is less than the least RSSI threshold RSSI_TH1, then RSSI 506 is less than all of RSSI thresholds RSSI_TH1, RSSI_TH2, . . . RSSI_THN, which means that all of RSSI threshold comparators 508_1, 508_2, . . . 508_N will output their corresponding RSSI threshold comparison outputs 510_1, 510_2, . . . 510_N as “0”s. Similarly, if RSSI 506 is greater than the largest RSSI threshold RSSI_THN, then RSSI 506 is greater than all of RSSI thresholds RSSI_TH1, RSSI_TH2, . . . RSSI_THN, which means that all of RSSI threshold comparators 508_1, 508_2, . . . 508_N will output their corresponding RSSI threshold comparison outputs 510_1, 510_2, . . . 510_N as “1”s. If RSSI 506 is greater than a first subset of one or more of the RSSI thresholds RSSI_TH1, RSSI_TH2, . . . RSSI_THN, but less than a second subset of one or more of the RSSI thresholds RSSI_TH1, RSSI_TH2, . . . RSSI_THN, then a corresponding first subset of RSSI threshold comparators 508_1, 508_2, . . . 508_N will output their corresponding first subset of RSSI threshold comparison outputs 510_1, 510_2, . . . 510_N as “1”s, while a second subset of RSSI threshold comparators 508_1, 508_2, . . . 508_N will output their corresponding second subset of RSSI threshold comparison outputs 510_1, 510_2, . . . 510_N as “0”s.

As illustrated in FIG. 5, adder 512 is provided in the adaptive acquisition threshold controller 502 to add RSSI threshold comparison outputs 510_1, 510_2, . . . 510_N of RSSI threshold comparators 508_1, 508_2, . . . 508_N. As can be recognized, sum 514 which is output by adder 512 may be an integer in the range of 0 to N, in increments of 1. Sum 514 is used to control selector 516. Selector 516 may be a multiplexer, for example, and is configured to select one of one or more scaling factors λ₀, λ₁, . . . λ_{N}, based on sum 514. For example, for values of sum 514=0, 1, . . . N, selector 516 may select a corresponding scaling factor λ₀, λ₁, . . . λ_{N} at its output, depicted as selected scaling factor 518. As can be recognized, selected scaling factor 518 may be adapted to or selected based on RSSI 506.

Also shown in FIG. 5, is multiplier 522 provided in adaptive acquisition threshold controller 502, configured to multiply initial acquisition threshold 404 with selected scaling factor 518, wherein the product or output of multiplier 522 is adaptive acquisition threshold 310 of adaptive acquisition threshold generator 308, discussed previously. Accordingly, adaptive acquisition threshold 310 is adapted to or based on the signal strength of the received signal, or RSSI 506 in exemplary aspects discussed herein.

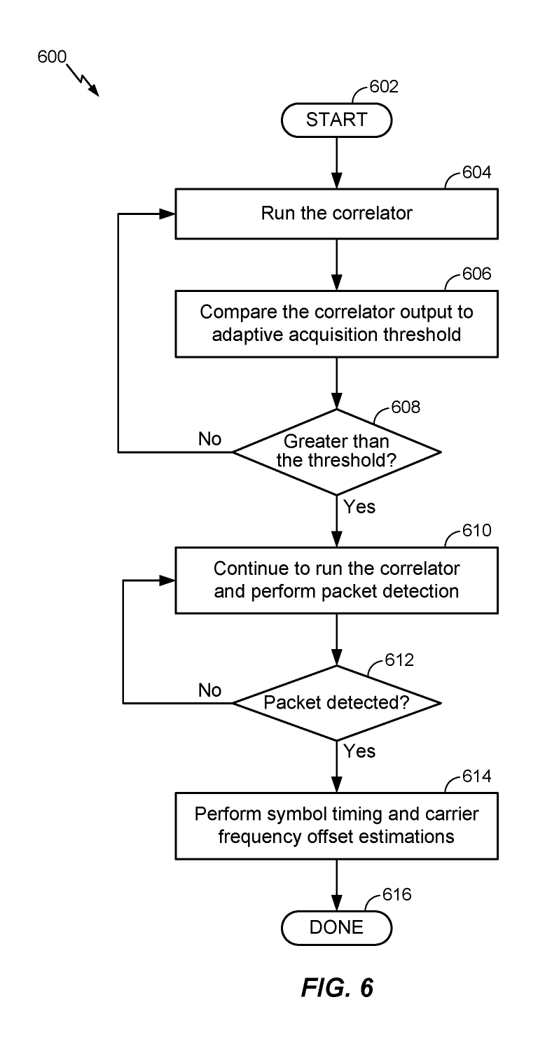

With reference now to FIG. 6 (along with combined references to FIGS. 1-5 discussed above), a flowchart pertaining to an example acquisition process 600 for Bluetooth and/or BLE signals at receiver 112 is illustrated. Process 600 starts in Block 602. In Block 604, correlator 302, for example, is run or configured to perform correlation of a received signal with a device identifier (e.g., a Bluetooth SyncWord or BLE AccessAddress of a wanted device, which may be stored in receiver 112), to generate a correlator output 306. In Block 306, correlator output 306, for example, is compared to adaptive acquisition threshold 310 (wherein, adaptive acquisition threshold 310 may be a scaled adaptive acquisition threshold produced by multiplying in multiplier 522, initial acquisition threshold 404 with selected scaling factor 518 based on comparisons of received signal strength RSSI 506 with one or more distinct RSSI thresholds RSSI_TH1, RSSI_TH2, . . . RSSI_THN).

With continuing reference to FIG. 6, in Block 608, a determination is made as to whether the correlator output is greater than the adaptive acquisition threshold in block 608, e.g., in comparator 312. If it is determined in Block 608 that correlator output 306 is not greater than adaptive acquisition threshold 310, then a wanted signal is not detected (e.g., wanted signal 318 is not asserted), and process 600 returns to Block 604 to repeat Block 606 until correlator output 306 is greater than adaptive acquisition threshold 310, i.e., a wanted signal is detected.

If, on the other hand, in Block 608, it is determined that correlator output 306 is greater than adaptive acquisition threshold 310, then a wanted signal is detected, e.g., wanted signal 318 is asserted. In this case, process 600 proceeds to Block 610, wherein correlator 302 is continued to run along with packet detector 320 to detect the peak of correlator output 306. In Block 612, a determination is made as to whether the peak of correlator output 306 has been detected, e.g., if packet detected 326 is asserted. If the peak of correlator output 306 packet is not detected, then process 600 returns to Block 610 to continue the processes running correlator 302 along with packet detector 320, until the peak of correlator output 306 is detected, e.g., packet detected 326 is asserted.

If packet detected 326 is asserted in Block 612, then symbol timing and carrier frequency offset estimations may be performed in Block 614, e.g., in symbol timing estimator 328 and carrier frequency offset estimator 330, respectively.

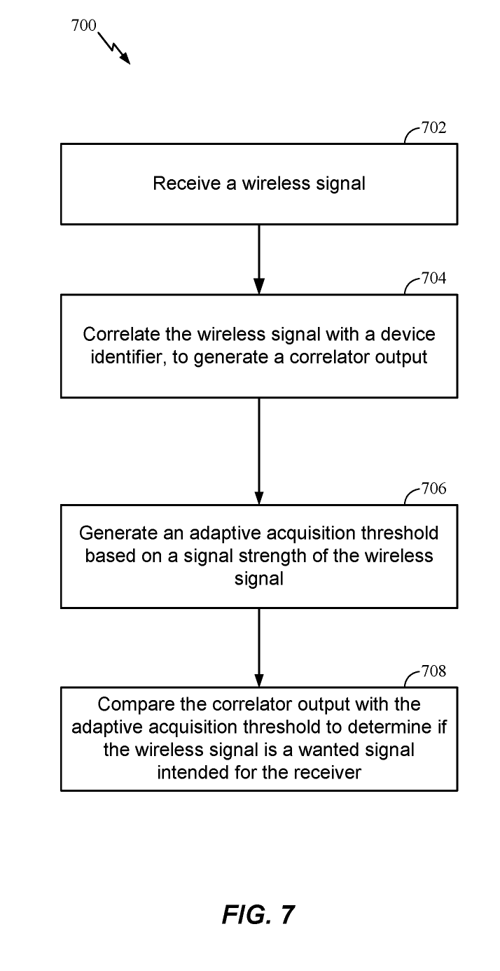

Accordingly, it will be appreciated that exemplary aspects include various methods for performing the processes, functions and/or algorithms disclosed herein. For example, FIG. 7 illustrates another flowchart pertaining to method 700 of operating a receiver, e.g., receiver 112 (or more specifically, acquisition block 120 of receiver 112) in accordance with aspects discussed above.

In Block 702, method 700 comprises receiving a wireless signal (e.g., received signal 304).

Block 704 comprises correlating (e.g., in correlator 302) the wireless signal with a device identifier (e.g., a SyncWord or AccessAddress, for Bluetooth or BLE signals, respectively, of a wanted device, wherein the device identifier may be stored in receiver 112), to generate a correlator output (e.g., correlator output 306).

Block 706 comprises generating an adaptive acquisition threshold (e.g., adaptive acquisition threshold 310 generated by adaptive acquisition threshold generator 308) based on a signal strength of the wireless signal (e.g., RSSI 306).

Block 708 comprises comparing (e.g., in comparator 312) the correlator output with the adaptive acquisition threshold to determine if the wireless signal is a wanted signal intended for the receiver (e.g., the wireless signal is determined to be a wanted signal if the correlator output is greater than the adaptive acquisition threshold).

Accordingly, it will be appreciated that aspects of this disclosure may relate to a system (e.g., wireless communication system 100 or, specifically, receiver 112 of FIG. 1). The system can include means for receiving a wireless signal (e.g., antenna 118), means for correlating the wireless signal with a device identifier (e.g., correlator 302), means for generating an adaptive acquisition threshold based on a signal strength of the wireless signal (e.g., adaptive acquisition threshold generator 308), and means for comparing an output of the means for correlating with the adaptive acquisition threshold, for determining if the wireless signal is a wanted signal for the means for system (e.g., comparator 312). Although not shown in the figures, the system can also include means for storing the device identifier, e.g., a storage medium or memory in receiver 112. The system can also include means for detecting a peak of the output of the means for correlating if the wireless signal is determined to be a wanted signal (e.g., packet detector 320), means for determining symbol timing of the wireless signal based on an output of the means for detecting (e.g., symbol timing estimator 328) and means for determining a carrier frequency offset of the wireless signal based on an output of the means for detecting (e.g., carrier frequency offset estimator 330).

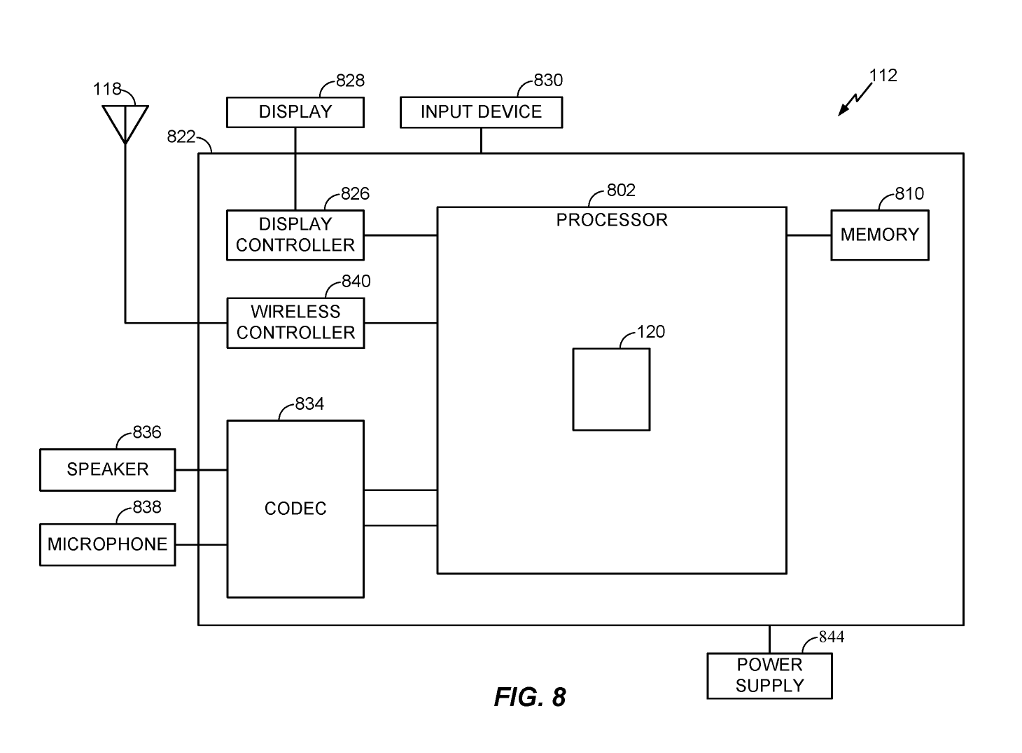

An example configuration of receiver 112 will now be discussed in relation to FIG. 8. FIG. 8 shows a block diagram of receiver 112, which can be a wireless device configured according to exemplary aspects. For example, receiver 112 of FIG. 8 can be configured to perform methods 600 and/or 700 of FIGS. 6-7 in some aspects. In further detail, receiver 112 is shown to include processor 802, which can be, for example, a digital signal processor (DSP) or any general purpose processor or central processing unit (CPU) as known in the art. In FIG. 8, acquisition block 120 is specifically illustrated within processor 802 while further details of acquisition block 120 that were shown in FIGS. 3-5 have been omitted from this depiction, for the sake of clarity. However, it will be understood that the implementation of receiver 112 discussed with reference to FIGS. 1-7 are applicable to the implementation shown in FIG. 8. Processor 802 may be communicatively coupled to memory 810, as shown (wherein, in some aspects, the device identifier may be stored in memory 810).

FIG. 8 also shows display controller 826 that is coupled to processor 802 and to display 828. Coder/decoder (CODEC) 834 (e.g., an audio and/or voice CODEC) can be coupled to processor 802. Other components, such as wireless controller 840 (which may include a modem) are also illustrated. Speaker 836 and microphone 838 can be coupled to CODEC 834. FIG. 8 also indicates that wireless controller 840 can be coupled to wireless antenna 118 (which was discussed in relation to FIG. 1). In a particular aspect, processor 802, display controller 826, memory 810, CODEC 834, and wireless controller 840 are included in a system-in-package or system-on-chip device 822.

In a particular aspect, input device 830 and power supply 844 are coupled to the system-on-chip device 822. Moreover, in a particular aspect, as illustrated in FIG. 8, display 828, input device 830, speaker 836, microphone 838, wireless antenna 842, and power supply 844 are external to the system-on-chip device 822. However, each of display 828, input device 830, speaker 836, microphone 838, wireless antenna 842, and power supply 844 can be coupled to a component of the system-on-chip device 822, such as an interface or a controller.

It should be noted that although FIG. 8 depicts a wireless communications device, processor 802 and memory 810, may also be integrated into a set top box, a music player, a video player, an entertainment unit, a navigation device, a personal digital assistant (PDA), a fixed location data unit, a computer, a laptop, a tablet, a communications device, a mobile phone, or other similar devices.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claimed subject matter.

The methods, sequences and/or algorithms disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, aspects of the claimed subject matter may include a non-transitory computer-readable media embodying a method for adapting acquisition threshold to received signal strength of wireless signals such as Bluetooth or BLE. Accordingly, the claimed subject matter is not limited to illustrated examples.

While the foregoing disclosure shows illustrative aspects of the claimed subject matter, it should be noted that various changes and modifications could be made herein without departing from the scope of the claimed subject matter. The functions, steps and/or actions of the method claims in accordance with the description herein need not be performed in any particular order. Furthermore, although aspects of the claimed subject matter may be described or claimed in the singular, the plural is contemplated unless limitation to the singular is explicitly stated.

What is claimed is:

1. An apparatus comprising:
a correlator configured to correlate a wireless signal received by the apparatus, with a device identifier, to generate a correlator output;
an adaptive acquisition threshold generator configured to generate an adaptive acquisition threshold based on a signal strength of the wireless signal; and
a comparator configured to determine if the wireless signal is a wanted signal for the apparatus, based on a comparison of the correlator output with the adaptive acquisition threshold.

2. The apparatus of claim 1, wherein the wireless signal is a Bluetooth signal.

3. The apparatus of claim 2, wherein the device identifier comprises a SyncWord corresponding to a wanted device that the apparatus wants to receive a Bluetooth packet from.

4. The apparatus of claim 1, wherein the wireless signal is a Bluetooth Low Energy (BLE) signal.

5. The apparatus of claim 4, wherein the device identifier comprises an AccessAddress corresponding to a wanted device that the apparatus wants to receive a BLE packet.

6. The apparatus of claim 1, wherein the adaptive acquisition threshold generator comprises one or more threshold comparators configured to compare the signal strength of the wireless signal with discrete signal strength threshold values, an adder configured to add outputs of the one or more threshold comparators to generate a sum, and a selector configured to select a selected scaling factor from one or more scaling factors, based on the sum.

7. The apparatus of claim 6, further comprising a multiplier configured to multiply an initial acquisition threshold with the selected scaling factor to generate the adaptive acquisition threshold.

8. The apparatus of claim 6, wherein the adaptive acquisition threshold generator comprises an initial acquisition threshold generator configured to generate an initial acquisition threshold based on the device identifier.

9. The apparatus of claim 1, wherein the device identifier is stored in the apparatus.

10. The apparatus of claim 1, further comprising a packet detector configured to detect a peak of the correlator output if the wireless signal is determined to be a wanted signal.

11. The apparatus of claim 10, further comprising a symbol timing estimator configured to determine symbol timing of the wireless signal for a packet detected by the packet detector.

12. The apparatus of claim 10, further comprising a carrier frequency offset estimator configured to determine a carrier frequency offset of the wireless signal for a packet detected by the packet detector.

13. The apparatus of claim 1, integrated into a device, selected from the group consisting of a set top box, a music player, a video player, an entertainment unit, a navigation device, a personal digital assistant (PDA), a fixed location data unit, a computer, a laptop, a tablet, a communications device, and a mobile phone.

14. A method of operating a receiver of wireless signals, the method comprising:
receiving a wireless signal;
correlating the wireless signal with a device identifier, to generate a correlator output;
generating an adaptive acquisition threshold based on a signal strength of the wireless signal; and
comparing the correlator output with the adaptive acquisition threshold to determine if the wireless signal is a wanted signal for the receiver.

15. The method of claim 14, wherein the wireless signal is a Bluetooth signal, and wherein the device identifier comprises a SyncWord corresponding to a wanted device that the receiver wants to receive a Bluetooth packet from.

16. The method of claim 14, wherein the wireless signal is a Bluetooth Low Energy (BLE) signal, and wherein the device identifier comprises an AccessAddress corresponding to a wanted device that the receiver wants to receive a BLE packet from.

17. The method of claim 14, wherein generating the adaptive acquisition threshold comprises:
comparing the signal strength of the wireless signal with discrete signal strength threshold values in one or more threshold comparators;
adding outputs of the one or more threshold comparators to generate a sum;
selecting a selected scaling factor from one or more scaling factors, based on the sum; and
multiplying an initial acquisition threshold with the selected scaling factor.

18. The method of claim 17, comprising generating the initial acquisition threshold based on the device identifier.

19. The method of claim 14, wherein the device identifier is stored in the receiver.

20. The method of claim 14, further comprising detecting a peak of the correlator output in a packet detector if the wireless signal is determined to be a wanted signal.

21. The method of claim 20, further comprising determining symbol timing of the wireless signal for a packet detected by the packet detector.

22. The method of claim 20, further comprising determining a carrier frequency offset of the wireless signal for a packet detected by the packet detector.

23. A system comprising:
means for receiving a wireless signal;
means for correlating the wireless signal with a device identifier;
means for generating an adaptive acquisition threshold based on a signal strength of the wireless signal; and
means for comparing an output of the means for correlating with the adaptive acquisition threshold, for determining if the wireless signal is a wanted signal for the system.

24. The system of claim 23, wherein the wireless signal is a Bluetooth signal, and wherein the device identifier comprises a SyncWord corresponding to a wanted device that the system wants to receive a Bluetooth packet from.

25. The system of claim 23, wherein the wireless signal is a Bluetooth Low Energy (BLE) signal, and wherein the device identifier comprises an AccessAddress corresponding to a wanted device that the system wants to receive a BLE packet from.

26. The system of claim 23, comprising means for storing the device identifier.

27. The system of claim 23, further comprising means for detecting a peak of the output of the means for correlating if the wireless signal is determined to be a wanted signal.

28. The system of claim 27, further comprising means for determining symbol timing of the wireless signal based on an output of the means for detecting.

29. The system of claim 27, further comprising means for determining a carrier frequency offset of the wireless signal based on an output of the means for detecting.

30. A non-transitory computer-readable storage medium comprising code, which, when executed by a processor, causes the processor to perform functions for operating a receiver, the non-transitory computer-readable storage medium comprising:
code for receiving a wireless signal;
code for correlating the wireless signal with a device identifier, to generate a correlator output;
code for generating an adaptive acquisition threshold based on a signal strength of the wireless signal; and
code for comparing the correlator output with the adaptive acquisition threshold to determine if the wireless signal is a wanted signal for the receiver.
